(19) United States
(12) Patent Application Publication
(10) Pub. No.: US 2017/0372496 A1
(43) Pub. Date: Dec. 28, 2017

(54) ANTI-CORRELATED NOISE FILTER

(71) Applicant: KONINKLIJKE PHILIPS N.V., EINDHOVEN (NL)

(72) Inventors: Kevin Martin BROWN, CHARDON, OH (US); Liran GOSHEN, PARDES-HANNA (IL); Asher GRINGAUZ, NESHER (IL); Stanislav ZABIC, LYNDHURST, OH (US)

(21) Appl. No.: 15/537,520

(22) PCT Filed: Dec. 7, 2015
(86) PCT No.: PCT/IB2015/059396

§ 371 Date: Jun. 19, 2017

Related U.S. Application Data
(60) Provisional application No. 62/095,121, filed on Dec. 22, 2014.
(60) Provisional application No. 62/237,262, filed on Oct. 5, 2015.

(51) Int. Cl. G06T 11/00

(52) U.S. Cl. CPC G06T 11/005; G06T 11/008; G06T 2211/408

(57) ABSTRACT

An imaging system (100) includes an anti-correlated noise filter (120), which jointly filters noise from a first portion (116) and a second portion (118), and the first portion (116) and the second portion (118) include anti-correlated noise.

### FIELD OF THE INVENTION

The following generally relates to filtering image data and finds particular application to spectral computed tomography (CT), but is also amenable to other imaging processing systems.

### BACKGROUND OF THE INVENTION

A computed tomography (CT) scanner includes an x-ray tube that emits radiation. The emitted radiation traverses an examination region with a subject or object located within and is detected by a detector array opposite from the x-ray tube. The detector array detects the radiation traversing the examination region and the subject located therein and generates projection data, e.g., raw detector data or projection images. A reconstructor processes the projection data and reconstructs a volumetric image of the subject or object.

A spectral CT scanner includes at least one x-ray tube that emits a high energy spectrum and a low energy spectrum of x-rays, which elicit different structural and spectral characteristics of the subject or object in the generated projection data. That is, the materials of the subject or object are attenuated depending on the energy used.

Filters can be used to reduce or suppress noise in either the projection data and/or in the reconstructed image. By reducing the noise in the projection data, e.g., projection space, or in the reconstructed image or image data, e.g., image space, the quality of the image can be improved, e.g., the structural and/or spectral characteristics of the subject or object are more visible. Filtering can also change the characteristics in the image while filtering noise and typically includes parameters or constraints to preserve the characteristics. The filters operate on each image or data independently. Particularly difficult is filtering low-frequency noise while preserving characteristics of the object or subject present at low- frequencies, such as real structures.

Noise is introduced by devices used to obtain the data. For example, the imaging device or scanner used to detect the x-ray radiation and generate the projection data introduces noise. Noise can also be introduced in the processing of the data. Basis decomposition processing splits or divides projection data and/or image data into spectral or energy dependent components or basis materials. Examples of decomposed spectral CT projection or image data include photoelectric absorption and Compton-scatter components, water and Iodine components, water and Calcium components, and acetal homopolymer resin, e.g., Delrin® and tin components, and/or other components including three or more basis materials rather than just pairs. The decomposition process introduces noise in pairs known as anti-correlated noise. Anti-correlated noise is introduced between two images or two projection data sets derived from a common image or common projection data set. The anti-correlated noise is negatively correlated between the image pairs or data set pairs, such that when the pairs are combined the noise is cancelled or absent. In other words, the noise introduced in each image or data set is of the same magnitude between pairs with different signs.

### SUMMARY OF THE INVENTION

Aspects described herein address the above-referenced problems and others. The following describes an approach to filtering anti-correlated noise from spectral projection data sets or image data sets. The approach uses an iterative algorithm to jointly process the data sets to reduce or suppress the anti-correlated noise in each of the projection data sets or image data sets while preserving structural and/or spectral aspects. The approach can include other filtering or image processing. In one instance, the approach filters the projection data sets. In another instance, the approach filters the image data sets.

In one aspect, an imaging system includes an anti-correlated noise filter, which jointly filters anti-correlated noise from a first portion and a second portion, and the first portion and the second portion include anti-correlated noise.

In another aspect, a method of filtering image data includes jointly filtering noise from a first portion and a second portion, and the first portion and the second portion include anti-correlated noise.

In another aspect, a non-transitory computer readable storage medium encoded with computer readable instructions, which, when executed by a processor, causes the processor to jointly filter noise from a first portion and a second portion. The first portion and the second portion include anti-correlated noise. The filter operates iteratively according to one of the following functions:

$$( \hat{p} , \hat{s} ) = arg {min}_{( p , s )} R ( p ) + R ( s ) + \frac{1}{2} \int {{λ}^{u} ( p + s - {u}^{0} )}^{2} + \frac{1}{2} \int {{λ}^{p} ( p - {p}^{0} )}^{2} + \frac{1}{2} \int {{λ}^{s} ( s - {s}^{0} )}^{2} ,$$

where R(p) and R(s) are roughness penalties or regularization terms for p and s, respectively, u⁰ is an image volume where the correlated noise maximally cancels out with the initially decomposed portions, p⁰ and s⁰, e.g., u⁰=p⁰+s⁰, p and s are the filtered image volumes, and λ^{u}, λ^{p} and λ^{s} are weights;

$$( \hat{s} , \hat{p} ) = arg {min}_{( s , p )} α R ( s ) + ( 1 - α ) R ( p )$$

subject to the constraints that (s.t.)
1. s and p are obtained by removing negatively correlated estimated noise from s⁰ and p⁰, respectively,
2. \hat{m} monochromatic image is unchanged, and
3. image frequencies outside band frequencies are unchanged,
   where R(p) and R(s) are roughness penalties or regularization terms for p and s, respectively, \hat{m} is an energy level parameter in keV unit, and α is an algorithm control parameter;

\hat{p}=p⁰−Â and ŝ=s⁰+Â,

where

$$\hat{A} = {\hat{A}}_{{L}_{1}} + ScaleUp ( {\hat{A}}_{{L}_{2}}^{d} - ScaleDown ( {\hat{A}}_{{L}_{1}} , d ) , d ) , \\ {\hat{A}}_{{L}_{1}} = {argmin }_{A} R ( {s}^{0} + A ) + R ( {p}^{0} - A ) + \int {λ}_{1} {h}_{δ} ( A ) , \\ {\hat{A}}_{{L}_{2}}^{d} = {argmin }_{A} R ( {s}_{d}^{0} + A ) + R ( {p}_{d}^{0} - A ) + \int {λ}_{2} {A}^{2} ,$$

s_{d}⁰=ScaleDown (s⁰, d), p_{d}⁰=ScaleDown (p⁰, d), d is a scale parameter, R(·) is a roughness penalty or regularization term, λ₁ and λ₂ and are weights, Â is the estimated anti-correlated noise image, A is a prior estimate of the anti-correlated noise image, h_{δ}(A)=δ²(\sqrt{1+(A/δ)²}−1) is the pseudo-Huber penalty function and δ is the pseudo-Huber parameter; or

\hat{p}=p⁰−Â and ŝ−s⁰+Â,

where

Â=Â_{L}_{₁}+ScaleUp (Â_{L}_{₂}^{d}, d),

$${\hat{A}}_{{L}_{1}} = {argmin }_{A} R ( {s}^{0} + A ) + R ( {p}^{0} - A ) + \int \frac{{λ}_{1}}{n} {h}_{δ} ( A ) , and$$

$${\hat{A}}_{{L}_{2}}^{d} = {argmin }_{A} R ( {s}_{d}^{0} + A ) + R ( {p}_{d}^{0} - A ) + \int ( \frac{{λ}_{2}}{{n}^{2}} + {λ}_{3} F ) {A}^{2} ,$$

where s_{d}⁰=ScaleDown (s⁰+Â_{L}_{₁}^{d}, d), p_{d}⁰=ScaleDown (p⁰−Â_{L}_{₁}, d), d is a scale parameter, R(·) is a roughness penalty or regularization term, λ₁, λ₂ and λ₃ are weights, Â is the estimated anti-correlated noise image, A is a prior estimate of the anti-correlated noise image, h_{δ}(A)=δ²(\sqrt{1+(A/δ)²}−1) is the pseudo-Huber penalty function, δ is the pseudo-Huber parameter, n is an estimated noise map, and

$$F = ScaleDown ( \frac{σ ( {s}_{d}^{0} + {\hat{A}}_{{L}_{1}} ) σ ( {p}_{d}^{0} - {\hat{A}}_{{L}_{1}} )}{1 - {σ ( {\hat{A}}_{{L}_{1}} )}^{2}} ) ,$$

where σ(x) is the local standard deviation of the image.

### BRIEF DESCRIPTION OF THE DRAWINGS

The invention may take form in various components and arrangements of components, and in various steps and arrangements of steps. The drawings are only for purposes of illustrating the preferred embodiments and are not to be construed as limiting the invention.

FIG. 1 schematically illustrates an example computing system with an anti-correlated noise filter.

FIG. 2 schematically illustrates an example of the spectral data manipulation and filtering with the anti-correlated noise filter and a first algorithm.

FIG. 3 schematically illustrates an example of the spectral data manipulation and filtering with the anti-correlated noise filter and a second algorithm.

FIG. 4 flowcharts a method of filtering anti-correlated noise in image pairs.

FIG. 5 flowcharts a method of filtering anti-correlated noise in projection data set pairs.

### DETAILED DESCRIPTION OF EMBODIMENTS

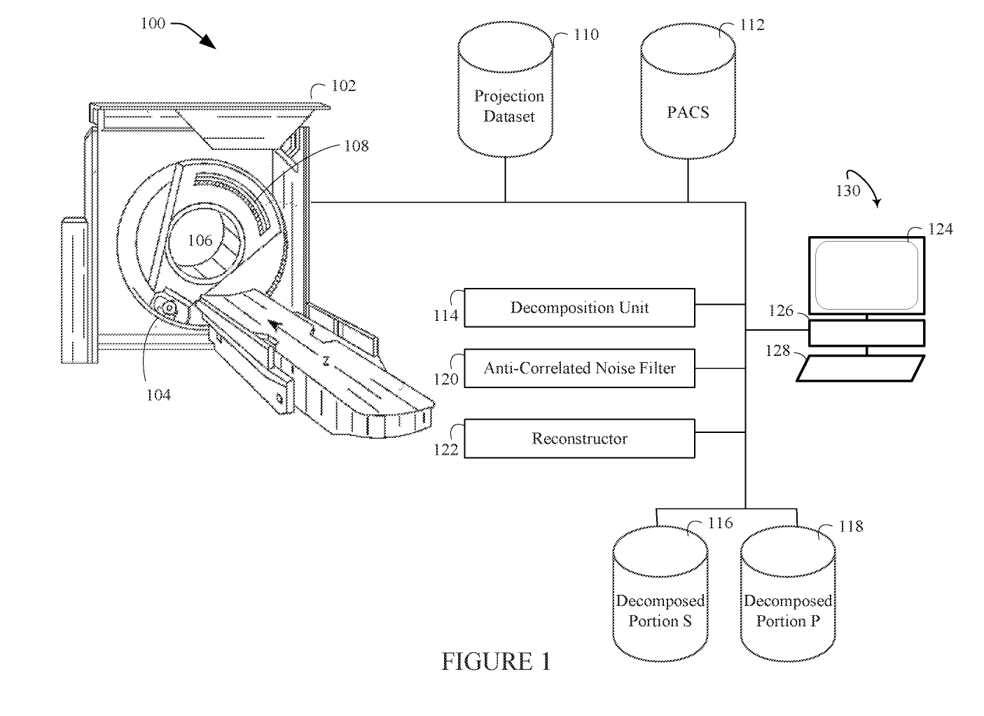

Initially referring to FIG. 1, an imaging system 100 includes an imaging scanner, such as a computed tomography (CT) scanner 102. The scanner is configured to generate projection data and/or images which decompose into anti-correlated portions. The scanner 102 includes one or more radiation sources 104, such as an x-ray tube, which emits radiation that traverses an examination region 106. In one instance, a mean or peak emission voltage of the radiation source 104 is switched between an emission voltage of two or more emission voltages (e.g., 80 and 140 kVp, 100 and 120 kVp, etc.). In another variation, the radiation source 104 includes a single broad spectrum x-ray tube.

A detector array 108 opposite the radiation source 104 detects the emitted radiation that traverses the examination region 106 and generates projection data 110 indicative of the object or subject in the examination region 106. Where the radiation source voltage is switched between at least two emission voltages and/or includes two or more x-ray tubes emit radiation at two different emission voltages, the detector array 108 generates projection data 110 for each of the radiation source voltages. For a single broad-spectrum x-ray tube, the detector array 108 includes an energy-resolving detector (e.g., multi-layered, photon counting, etc.) that produces the spectral projection data 110.

The projection data 110 can be represented as projection images, sinograms, and the like. The projection data 110 can include data organization, such as file and/or data set organization, database organizations, object and/or element definition, and the like. The projection data 110 can be stored in random access memory, such as computer memory, local memory, server memory, cloud storage, server storage, local storage, solid state storage, flash storage and the like. In one instance, the projection data 110 is stored in a Picture Archiving and Communication System (PACS) 112, Radiology Information System (RIS), Hospital Information System (HIS), Electronic Medical Record (EMR) or other system or device communicatively connected to the system 100.

A decomposition unit 114 decomposes the projection data into at least a first portion 116 and a second portion 118, such as a pair of data sets or data structures. Each portion includes noise, which is anti-correlated with noise in the other portion. For example, the decomposition unit 114 decomposes spectral projection data into photoelectric and Compton-scatter components, water and Iodine components, water and Calcium components, or acetal homopolymer resin, e.g., Delrin® and tin components, and/or other basis material sets.

An anti-correlated noise filter 120 jointly processes the first portion 116 and second portion 118. The anti-correlated noise filter 120 iteratively filters the first portion 116 and second portion 118. The anti-correlated noise filter 120 receives two projection data sets or image data sets as input and outputs two anti-correlated noise filtered projection data sets or image data sets. The iteration can be performed until a stopping criteria is reached, such as a predetermined number of iterations, a predetermined elapsed time, a difference between the input pairs and the output pairs satisfying a predetermined difference, combinations thereof, and the like. As described in greater detail below, the anti-correlated noise filter 120 jointly filters according to a function of a first algorithm or a second algorithm, which minimizes the anti-correlated noise. The functions are implemented by one or more methods, which filter out the anti-correlated noise in the output projection data sets or image data sets.

A reconstructor 122 reconstructs the filtered first portion 116 and second portion 118 into each into an image and/or a combined image. In one instance, the reconstructor 122 reconstructs each of the filtered first portion 116 and the filtered second portion 118, each into separate images. The separate images can be combined to form a combined image which is displayed on a display device 124. In another instance, the filtered first portion 116 and filtered second portion 118 are combined in projection space and then reconstructed as one image, which is displayed on the display device 124 and/or stored, such as in the PACS 112.

In one instance, the reconstructor 122 reconstructs the first portion 116 and second portion 118, e.g., from projection space, into images, e.g., into image space, and the anti-correlated noise filter 120 jointly filters the reconstructed images of the reconstructed first portion 116 and the reconstructed second portion 118. The filtered reconstructed first portion 116 and the filtered reconstructed second portion 118 can be combined into an image or otherwise manipulated. The combined image is displayed on the display device 124 and/or stored in the PACS 112.

The decomposition unit 114, the anti-correlated noise filter 120 and the reconstructor 122 are suitably embodied by a data processor 126, such as a electronic data processor, microprocessor, digital processor, optical processor, and the like, configured to execute computer readable instructions stored in a non-transitory computer readable storage medium or computer readable memory, e.g., software.

The processor 126 can also execute computer readable instructions carried by a carrier wave, a signal or other transitory medium to perform the disclosed techniques. The processor 126 can receive parameters through one or more input devices 128, such as a keyboard, mouse, touch screen, microphone, and the like. The processor 126, display device 124 and input device 128 can comprise a computing device 130, such as a desktop computer, laptop, smartphone, body worn device, distributedly connected computing devices, such as a server and a communicatively connected peer or client computer, and the like.

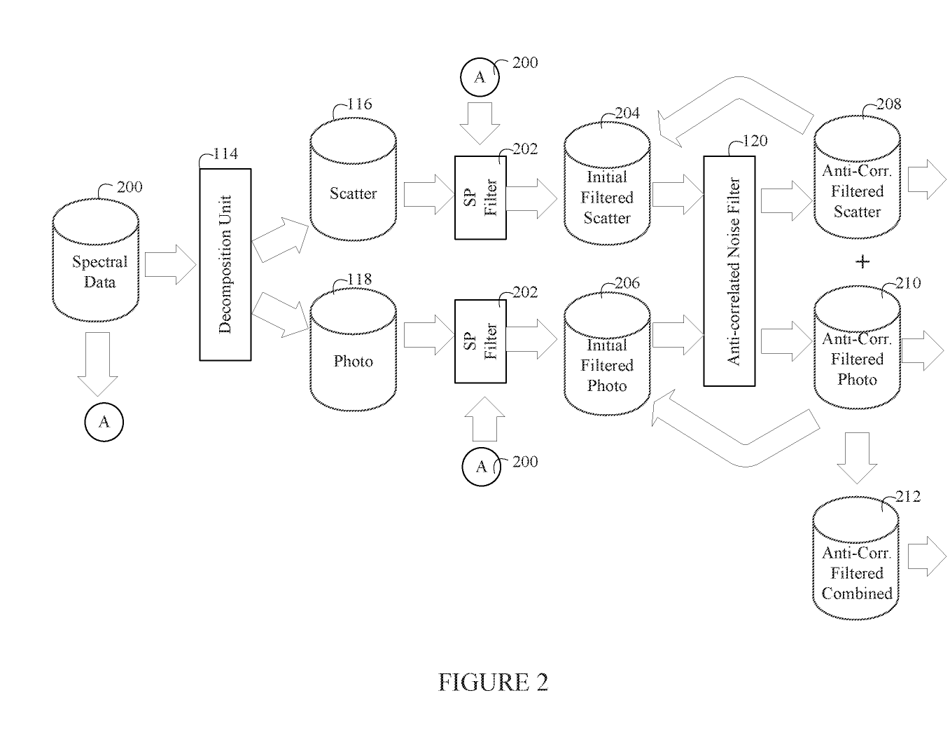

With reference to FIG. 2, an example of spectral data 200 manipulation and filtering with the anti-correlated noise filter and a first algorithm is schematically illustrated. The spectral data 200 can include either the projection data 110 or reconstructed image data. The decomposition unit 114 decomposes the spectral data 200 into the first portion 116, such as Compton scatter or scatter, and into the second portion 118, such as photoelectric or photo.

A Structure Propagation (SP) filter 202 can be used to initially filter the decomposed portions individually. The SP filter 202 can be a bi-lateral filter that uses information on edges of the combined image 200 or a weighted combination. The output is an initially filtered first portion 204 and an initially filtered second portion 206. In a variation, the SP filter 202 is omitted.

The anti-correlated noise filter 120 iteratively filters the initially filtered first portion 204 and an initially filtered second portion 206. In one instance, the initially filtered first portion 204 and an initially filtered second portion 206 are the first portion 116 and the second portion 118, e.g., without the SP filter 202. The anti-correlated noise filter 120 uses a minimization function in a first algorithm to iteratively filter the decomposed image volume pair s⁰ 204 and p⁰ 206 from the combined projection data or image volume u⁰. An example minimization function is shown in EQUATION 1:

$$( \hat{p} , \hat{s} ) = arg {min}_{( p , s )} R ( p ) + R ( s ) + \frac{1}{2} \int {{λ}^{u} ( p + s - {u}^{0} )}^{2} + \frac{1}{2} \int {{λ}^{p} ( p - {p}^{0} )}^{2} + \frac{1}{2} \int {{λ}^{s} ( s - {s}^{0} )}^{2} , \qquad EQUATION 1$$

where R(p) and R(s) are roughness penalties or regularization terms for p and s, respectively, u⁰ is an image volume where the correlated noise maximally cancels out with the initially decomposed portions, p⁰ and s⁰, e.g., u⁰=p⁰+s⁰, p and s are the filtered image volumes, and λ^{u}, λ^{p} and λ^{s} are weights. In one instance, the roughness penalty includes a Huber penalty, such as

$$R ( p ) = \int {h}_{δ} ( ∇ p ) , where {h}_{δ} ( ∇ p ) = \{ \begin{matrix}\frac{1}{2} {( ∇ p )}^{2} & if \vert ∇ p \vert \leq δ \\ δ ( \vert ∇ p \vert - \frac{1}{2} δ ) & otherwise\end{matrix}$$

and δ is a Huber parameter. R(s) is similarly constructed. In another instance, R(p)is a total variation penalty, such as R(p)=∫|V̅p|. The constraint λ^{u} (p+s−u⁰) ensures that the edges are maintained in the original minimal noise (sum) image volume u⁰, while the constraints λ^{p} (p−p⁰) and λ^{s} (s−s⁰) reduce the amount of crosstalk between the image volumes p and s. The weights provided by the lambda's can be adjusted to provide different trade-offs between smoothing and edge preservation and can vary across each image volume. If noise in the initial image volumes p⁰ and s⁰ is not perfectly anti-correlated,the image volumes can be balanced by scaling both portions, such as b₁p⁰ and b₂s⁰, where b₁ and b₂ are scaling factors are picked so that the anti-correlated noise completely cancels out in the sum u₀=b₁p⁰+b₂s⁰.

The minimization function of EQUATION 1 can be implemented by iterative update functions shown in EQUATIONS 2 and 3:

$$\begin{matrix}{s}_{i , j , k}^{n + 1} = \frac{{λ}_{i , j , k}^{u} ( {u}_{i , j , k}^{0} - {p}_{i , j , k}^{n} ) + {λ}_{i , j , k}^{s} {s}_{i , j , k}^{0} + {δΣ}_{D} {σ}_{D}^{n} {s}_{D}^{n}}{{λ}_{i , j , k}^{u} + {λ}_{i , j , k}^{s} + {δΣ}_{D} {σ}_{D}^{n}} & EQUATION 2 \\ {p}_{i , j , k}^{n + 1} = \frac{{λ}_{i , j , k}^{u} ( {u}_{i , j , k}^{0} - {s}_{i , j , k}^{n} ) + {λ}_{i , j , k}^{p} {s}_{i , j , k}^{0} + {δΣ}_{D} {ϕ}_{D}^{n} {s}_{D}^{n}}{{λ}_{i , j , k}^{u} + {λ}_{i , j , k}^{p} + {δΣ}_{D} {ϕ}_{D}^{n}} , & EQUATION 3\end{matrix}$$

where λ^{u}, λ^{p} and λ² are weights, is the initial combined image or projection data, p⁰ and s° are the initial input images or projection data, pⁿ and sⁿ are current values of the n^{th} iteration, pⁿ⁺¹ and sⁿ⁺¹ are the next iteration filtered projection data or images, D includes a set of each orthogonal direction {E(ast), W(est), S(outh), N(orth), U(p), and (d)O(wn))}, and i,j,k represent a current voxel in the image or position in projection space volume, and δ is a Huber parameter. The weights, σ of s and φ of p, for each direction, such as E(east), are given by EQUATION 4 and EQUATION 5:

$$\begin{matrix}{σ}_{E , 1}^{n} = \sqrt{\begin{matrix}\frac{{( {s}_{E} - s )}^{2}}{{d}_{y}^{2}} + \frac{{( {s}_{N} + {s}_{NE} - {s}_{S} - {s}_{SE} )}^{2}}{4 {d}_{x}^{2}} + \\ \frac{{( {s}_{U} + {s}_{EU} - {s}_{O} - {s}_{EO} )}^{2}}{4 {d}_{z}^{2}}\end{matrix}} ; & EQUATION 4 \\ {ϕ}_{E , 1}^{n} = \sqrt{\begin{matrix}\frac{{( {p}_{E} - p )}^{2}}{{d}_{y}^{2}} + \frac{{( {p}_{N} + {p}_{NE} - {p}_{S} - {p}_{SE} )}^{2}}{4 {d}_{x}^{2}} + \\ \frac{{( {p}_{U} + {p}_{EU} - {p}_{O} - {p}_{EO} )}^{2}}{4 {d}_{z}^{2}}\end{matrix}} , & EQUATION 5\end{matrix}$$

where s and p are the corresponding current voxels, e.g., s_{i,j,k}ⁿ and p_{i,j,k}ⁿ, and subscripts E, N, NE, S, SE, U, EU, O, EO refer to the voxels or pixels east, north, northeast, south, southeast, up, east up, down, and east down, respectively of the current voxel or pixel, e.g., the voxels in orthogonally adjacent voxels, e.g., E, N, S, U, and O, which are not opposite or west, and two additional voxels east of the current voxel, which are not orthogonal and in the same direction, such as NE and SE, dₓis the voxel distance in the North/South direction in the image volume, d_{y} is the voxel distance in the East/West direction in the image volume, d_{z} is the voxel distance in the Up/Down direction in the image volume. The weighing is derived analogously for each remaining direction. In each direction D ∈ (E, W, N, S, U, O), the weights σ_{D,1} and φ_{D,1} are adjusted to

$${σ}_{D} = \frac{1}{{d}_{D} max ( {σ}_{D , 1} , δ )} and {ϕ}_{D} = \frac{1}{{d}_{D} max ( {ϕ}_{D , 1} , δ )}$$

and used in update equations 2 and 3, where dₛ, d_{N}:=dₓ; d_{E}, d_{W}=d_{y}; and d_{U}, d_{O}=d_{z}.

The output of each iteration is an anti-correlated noise filtered first portion 208 and an anti-correlated second portion 210, such as the sⁿ⁺¹ and the pⁿ⁺¹ projection data or image volume. The output is used as the input in a next iteration. The anti-correlated noise filtered first portion 208 and the anti-correlated second portion 210 as projection data can be reconstructed into separate images and then combined as an anti-correlated filtered image 212. The anti-correlated noise filtered first portion 208 and the anti-correlated second portion 210 as reconstructed images can be combined as the anti-correlated filtered image 212.

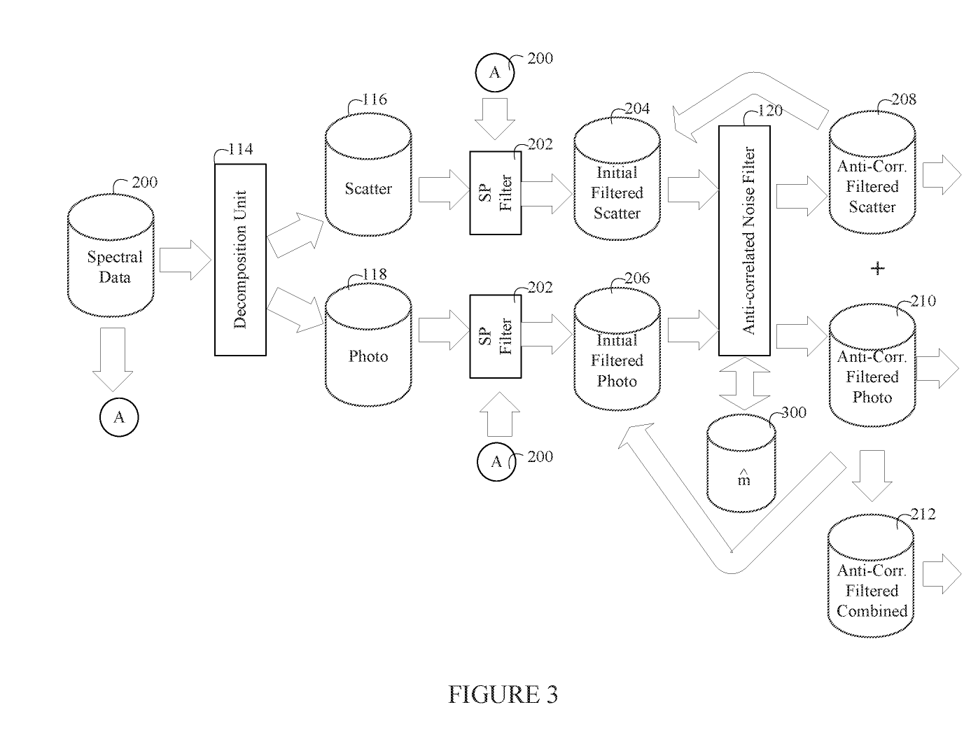

With reference to FIG. 3, an example of the spectral data manipulation and filtering with the anti-correlated noise filter 120 and a second algorithm is schematically illustrated. The spectral data 200 can include either the projection data 110 or image data. The decomposition unit 114 decomposes the spectral data 200 into the first portion 116, such as the Compton scatter or scatter, and into the second portion 118, such as the photoelectric or photo.

The denoising Structure Propagation (SP) filter 202 can be used to initially filter the decomposed portions individually. In one instance, the SP filter is omitted. The output is an initially filtered first portion 204 and an initially filtered second portion 206. The anti-correlated noise filter 120 iteratively filters the initially filtered first portion 204 and an initially filtered second portion 206. In one instance, the initially filtered first portion 204 and an initially filtered second portion 206 are the first portion 116 and the second portion 118, e.g., without the SP filter 202. The anti-correlated noise filter 120 uses a minimization function of a second algorithm to iteratively filter the decomposed image pair s⁰ 204 and p⁰ 206 from the combined projection data or image u⁰. An example of the constrained minimization function of the second algorithm is shown in EQUATION 6:

$$( \hat{s} , \hat{p} ) = arg {min}_{( s , p )} α R ( s ) + ( 1 - α ) R ( p ) \qquad EQUATION 6$$

subject to the constraints that (s.t.)
1. s and p are obtained by removing negatively correlated estimated noise from s⁰ and p⁰, respectively;
2. \hat{m} monochromatic image is unchanged; and
3. image frequencies outside band frequencies are unchanged,
   where R(p) and R(s) are roughness penalties or regularization terms for p and s, respectively, such as R(x)=∫|V̅x|, \hat{m} is an energy level parameter in keV unit, and α is an algorithm control parameter with a default value, such as equal to 0.5.

The minimization constrained by the condition that the virtual monochromatic image or projection data with energy \hat{m} does not change. The energy \hat{m} 300 is selected such that its anti-correlated noise is minimized. In one instance, \hat{m} is defined by:

$$\hat{m} = arg {min}_{m} \frac{R ( {c}_{s} ( m ) s + {c}_{P} ( m ) p )}{{c}_{s} ( m ) R ( s ) + {c}_{p} ( m ) R ( p )} , \qquad EQUATION 7$$

where R is a regularization function, cₛ(m) and cₚ(m) are the coefficients of the s and p, respectively, to obtain the monochromatic image for energy m in keV.

In another instance, the spectral virtual monochromatic image, \hat{m}, is detected by defining a selection region of the combined spectral data 200 using a predetermined threshold value, such as −200 HU. A local standard deviation is calculated for a neighborhood of size ne for the combined spectral data 200. A set, q of locations is created of the r smallest local standard deviations located in the selection region and an example of \hat{m} is defined in EQUATION 8:

$$\hat{m} = arg {min}_{m} Σ localstddev ( {c}_{s} ( m ) s + {c}_{p} ( m ) p , q , ne ) , \qquad EQUATION 8$$

where the local standard deviation is calculated only over the set q and ne specifies the neighbourhood of the local standard deviation.

The minimization function of EQUATION 6 is constrained to process image frequencies only within a band of frequencies, this is obtained as follows: the input p and s images are down scaled by a factor of d, which includes the range (0,1] and 1 is no scaling, 0.5 is scaling by a factor of 2, 0.25 is scaling down by a factor of 4, etc. Scaling down the images combines pixels through averaging and/or interpolation. The following optimization, EQUATION 9, is performed, using for example the lagged diffusivity fixed point iteration algorithm:

$$\hat{A} = arg {min}_{A} α R ( {s}_{d} + {c}_{p} ( \hat{m} ) A ) + ( 1 - α ) R ( {p}_{d} - {c}_{s} ( \hat{m} ) A ) \qquad EQUATION 9$$

where α is an algorithm control parameter, R is the roughness penalties or regularization terms, cₛ(\hat{m}) and cₚ(\hat{m}) are the coefficients of the downscaled images s_{d} and p_{d}, respectively, that enable the algorithm to obtain the monochromic image for energy \hat{m} keV, d is the downscaling factor, and Â is the estimate of the anti-correlated noise image. The denoised down scaled s and p image are defined in EQUATION 10 and 11:

s_{d}^{denoised}=s_{d}+cₚ(\hat{m})Â and p_{d}^{denoised}=p_{d}−cₛ(\hat{m})Â. EQUATION 10 and 11

The denoised down scaled monochromatic image at energy \hat{m} in keV doesn't change, as shown in an example EQUATION 12:

$${I}_{d , \hat{m} ke V}^{denoised} = {c}_{p} ( \hat{m} ) {p}_{d}^{denoised} + {c}_{p} ( \hat{m} ) {s}_{d}^{denoised} = {c}_{p} ( \hat{m} ) ( {p}_{d} - {c}_{s} ( \hat{m} ) \hat{A} ) + {c}_{s} ( \hat{m} ) ( {s}_{d} + {c}_{p} ( \hat{m} ) \hat{A} ) = {c}_{p} ( \hat{m} ) {p}_{d} + {c}_{s} ( \hat{m} ) {s}_{d} = {I}_{d , \hat{m} ke V} \qquad EQUATION 12$$

The denoised down scaled monochromatic images are scaled up to generate the \hat{p} and ŝ output images, in which only image frequencies within a band of frequencies were processed. Examples of scaling up the denoised down scaled monochromatic images are shown in EQUATIONS 13-16:

sₜ=s+ScaleUp(s_{d}+cₚ (\hat{m})Â−ScaleDown (s, d), d)=s+ScaleUp(cₚ (\hat{m})Â, d) and ŝ=sₜ+ScaleUp (ScaleDown(s−sₜ, u), u) EQUATION 13 and 14

pₜ=p+ScaleUp(p_{d}−cₛ(\hat{m})Â−ScaleDown (p,d),d)=p−ScaleUp(cₛ(\hat{m})Â, d) and \hat{p}=pₜ+ScaleUp (ScaleDown(p−pₜ, u), u), EQUATION 15 and 16

where u is a scale factor parameter, such as u=1/16.

The operator sᵤ=ScaleUp(s,u) returns the image sᵤ that is

$$\frac{1}{u}$$

times the size of the image s, and the operator s_{d} =ScaleDown(s,d) returns the image s_{d} that is d times the size of the image s_{d}=ScaleDown(s,d) returns the image s_{d} that is d times the size of the image s. Note that sₜ and pₜ represent intermediate results in which the image high frequency are preserved, i.e., the high frequencies of the images sₜ and pₜ are very similar to the high frequencies of the input images s and p, respectively.

The output of each iteration is an anti-correlated noise filtered first portion 208 and an anti-correlated second portion 210, such as the Ŝ and the \hat{P} projection data or image. The output is used as the input in a next iteration. The anti-correlated noise filtered first portion 208 and the anti-correlated second portion 210 as projection data can be reconstructed into separate images and then combined as an anti-correlated filtered image 212. The anti-correlated noise filtered first portion 208 and the anti-correlated second portion 210 as reconstructed images can be combined as the anti-correlated filtered image 212. In another instance, the filter includes minimization of the following two functionals:

$$\hat{A} = {arg min}_{A} R ( {s}^{0} + A ) + R ( {p}^{0} - A ) + \int {λ}_{1} {h}_{δ} ( A ) \\ \hat{A} = {arg min }_{A} R ( {s}^{0} + A ) + R ( {p}^{0} - A ) + \int {λ}_{2} {A}^{2} , \qquad EQUATION 17 and 18$$

where R(·) is a roughness penalty or regularization term, λ₁ and λ₂ are weights, Â is the estimated anti-correlated noise image, h₆₇ (A)=δ²(\sqrt{1+(A/δ)²}−1) is the pseudo-Huber penalty function and δ is the pseudo-Huber parameter. EQUATION 17 is applied to the p⁰ and s⁰ images using, for example, a lagged diffusivity fixed point iteration algorithm according to EQUATION 19.

$${\hat{A}}_{{L}_{1}} = {arg min}_{A} R ( {s}^{0} + A ) + R ( {p}^{0} - A ) + \int {λ}_{1} {h}_{δ} ( A ) . \qquad EQUATION 19$$

EQUATION 18 is applied to on the scaled down p⁰ and s⁰ images, with an optimization performed using, for example, the lagged diffusivity fixed point iteration algorithm according to EQUATION 20.

$${\hat{A}}_{{L}_{2}}^{d} = {arg min}_{A} R ( {s}_{d}^{0} + A ) + R ( {p}_{d}^{0} - A ) + \int {λ}_{2} {A}^{2} , \qquad EQUATION 20$$

where s_{d}⁰=ScaleDown (s⁰, d) and p_{d}⁰=ScaleDown (p⁰, d). The filtered images are obtained by combining the estimates from EQUATIONS 19 and 20 according to EQUATION 21.

Â=Â_{L}_{₁}+ScaleUp (Â_{L}_{₂}^{d}−ScaleDown (Â_{L}_{₁}, d),d), \hat{p}=p⁰−Â and ŝ=s⁰+Â, EQUATION 21

where Â is the final estimate for the anti-correlated noise image, \hat{p} and ŝ are the denoised photo and scatter images, respectively.

A third algorithm uses an estimated noise map and filters the anti-correlated noise with an minimization function as defined in EQUATION 22. The estimate noice map, n, is estimated using noise modeling techniques, such as with a Monte Carlo estimate, by analytical methods such as by Wunderlich and Noo in “Image Covariance and Lesion Detectability in Direct Fan-Beam X-Ray Computed Tomorgraph”, or direct extraction techniques, such as described in U.S. Pat. No. 8,938,110.

Â=Â_{L}_{₁}+ScaleUp(Â_{L}_{₁}^{d}, d) \hat{p}=p⁰−Â and ŝ=s⁰+Â, EQUATION 22

where Â is the estimated anti-correlated noise image, \hat{p} and ŝ are the denoised photo and scatter images, respectively, and p⁰ and s⁰ are the initial or input photo and scatter images, respectively, d is a scale parameter, and Â_{L}_{₁} and Â_{L}_{₂}^{d} are defined by EQUATION 23 and 24 respectively.

$${\hat{A}}_{{L}_{1}} = {arg min}_{A} R ( {s}^{0} + A ) + R ( {p}^{0} - A ) + \int \frac{{λ}_{1}}{n} {h}_{δ} ( A ) . \qquad EQUATION 23$$

where R is a roughness penalty or regularization term, such as ∫ h_{δ}(|V̅p|), A is the image, n is the estimated noise map, λ₁ is a weight, and h₆₇ (A)=δ²(\sqrt{1+(A/δ)²}−1) is the pseudo-Huber penalty function and δ is the pseudo-Huber parameter. EQUATION 23 is applied to on the scaled down p⁰ and s⁰ images, with an optimization performed using, for example, the lagged diffusivity fixed point iteration algorithm according to EQUATION 24.

$${\hat{A}}_{{L}_{2}}^{d} = {arg min}_{A} R ( {s}_{d}^{0} + A ) + R ( {p}_{d}^{0} - A ) + \int ( \frac{{λ}_{2}}{{n}^{2}} + {λ}_{3} F ) {A}^{2} , \qquad EQUATION 24$$

where s_{d}⁰=ScaleDown (s⁰+Â_{L}_{₁}, d) and p_{d}⁰=ScaleDown (p⁰−Â_{L}_{₁}, d), λ₂ and λ₃ are weights and F is defined by EQUATION 25.

$$F = ScaleDown ( \frac{σ ( {s}_{d}^{0} + {\hat{A}}_{{L}_{1}} ) σ ( {p}_{d}^{0} - {\hat{A}}_{{L}_{1}} )}{1 + {σ ( {\hat{A}}_{{L}_{1}} )}^{2}} ) , \qquad EQUATION 25$$

where σ(x) is the local standard deviation of the image ^{x}.

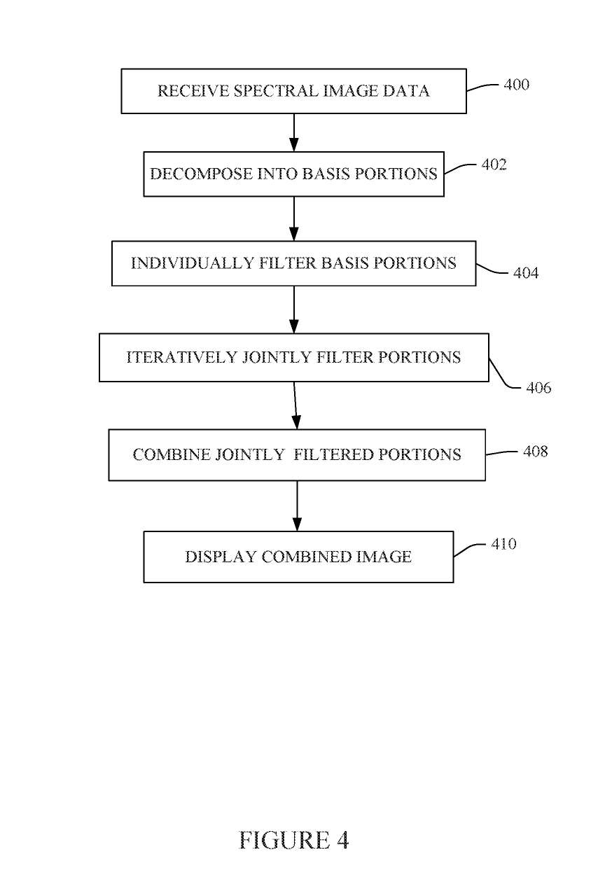

With reference to FIG. 4, a method of filtering anti-correlated noise in image pairs is flowcharted. It is to be appreciated that the ordering of the acts is not limiting. As such, other orderings are contemplated herein. In addition, one or more acts may be omitted and/or one or more additional acts may be included.

At 400, spectral image data is received, such as the spectral image data 200 described in reference to FIGS. 2 and 3. The spectral image data can be received from memory, such as the PACS 112, or from the reconstructor 122.

The spectral image data is decomposed at 402 into the first decomposed portion, such as Compton scatter, and the second decomposed portion, such as the photoelectric absorption. The decomposed first and second portions include anti-correlated noise.

At 404, each of the decomposed first and second portions can be individually filtered. For example, the first and second portions are each filtered separately with the SP filter 202 using information from the combined image 200 or spectral image data.

At 406, the decomposed pair of images from 402 or the individual filtered pair from 404 are iteratively filtered as a pair using the anti-correlated noise filter 120 as described in reference to FIG. 1 and as examples in reference to FIGS. 2 and 3. The iterative algorithms can be repeated until a stopping criteria is reached, such as a number of iterations, an elapse time, or a threshold change between characteristics of the input images and the output images, a combination, and the like.

At 408, the output images are combined in memory. The output images can be further manipulated, such as other filtering, computations, segmentation, and the like before combining.

The combined image is displayed on a display device 124 at 410. The display can include displaying the output images, i.e., anti-correlated noise filtered images. The combined image can also be output on film by a filmer or the like.

The above may be implemented by way of computer readable instructions, encoded or embedded on non-transitory computer readable storage medium, which, when executed by a computer processor(s), cause the processor(s) to carry out the described acts. Additionally or alternatively, at least one of the computer readable instructions is carried by a signal, carrier wave or other transitory medium.

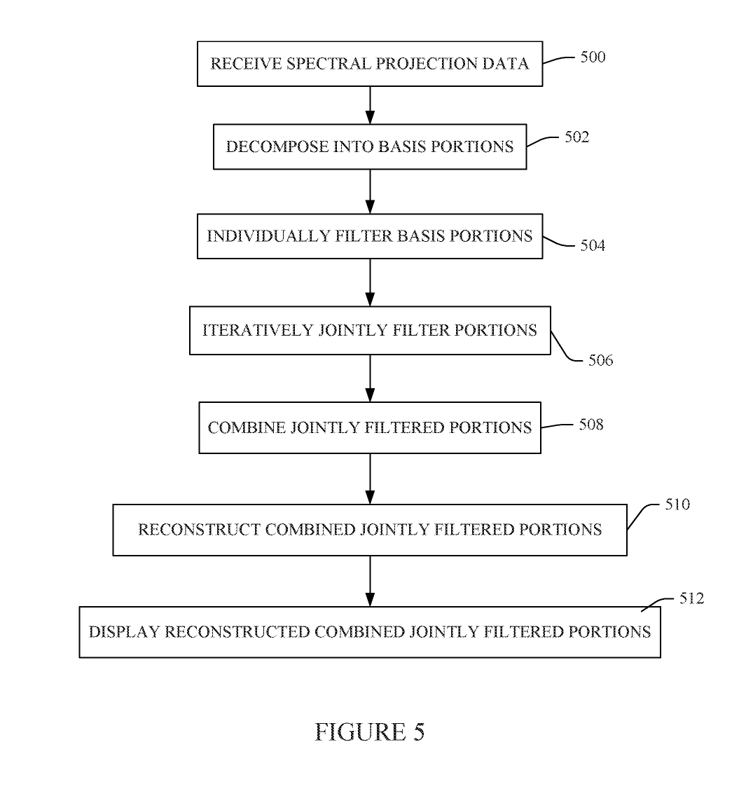

With reference to FIG. 5, a method of filtering anti-correlated noise in projection data set pairs is flowcharted. At 500, spectral image data is received, such as the spectral image data 200 described in reference to FIGS. 2 and 3. The spectral image data can be received from memory, such as the PACS 112, or from the imaging scanner, such as the CT scanner 102.

The spectral image data is decomposed at 502 into the first decomposed portion, such as Compton scatter, and the second decomposed portion, such as the photoelectric absorption. The decomposed first and second portions include anti-correlated noise.

At 504, each of the decomposed first and second portions can be individually filtered. For example, the first and second portions are each filtered separately with the SP filter 202 using information from the combined image 200 or spectral image data.

At 506, the decomposed pair of projection data sets from 502 or the individual filtered pair from 504 are iteratively filtered as a pair using the anti-correlated noise filter 120 as described in reference to FIG. 1 and as examples in reference to FIGS. 2 and 3. The iterative algorithms can be repeated until a stopping criteria is reached, such as a number of iterations, an elapse time, or a threshold change between characteristics of the input images and the output images, a combination, and the like.

At 508, the output data sets are combined in memory. The output data sets can be further manipulated, such as other filtering, computations, segmentation, and the like before combining. At 510, the combined output data set is reconstructed by the reconstructor 122 into an image. Alternatively, 510 and 508 can be reversed, and the output data sets are reconstructed each into an image, and the two reconstructed images are combined.

The combined image is displayed on a display device 124 at 512. The display can include displaying the output images, i.e., anti-correlated noise filtered images. The combined image can also be output on film by a filmer or the like.

The above may be implemented by way of computer readable instructions, encoded or embedded on non-transitory computer readable storage medium, which, when executed by a computer processor(s), cause the processor(s) to carry out the described acts.

Additionally or alternatively, at least one of the computer readable instructions is carried by a signal, carrier wave or other transitory medium.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. An imaging system comprising:
an anti-correlated noise filter configured to jointly filter noise from a first portion and a second portion, and the first portion and the second portion include anti-correlated noise.

2. The imaging system according to claim 1, wherein the first portion and the second portion include spectral CT data from a basis decomposition of at least one of:
projection data of an object or subject; or
image data of an object or subject.

3. The imaging system according to claim 1, wherein the anti-correlated noise filter jointly filtered noise is suppressed based on at least one of:
a weighted difference between initially combined data of the first portion and the second portions, and a sum of a filtered first portion and a filtered second portion; and
the filtered first portion and the filtered second portion selected to minimize noise in a spectral monochromatic image which includes a weighted combination of the filtered first portion and the filtered second portion.

4. The imaging system according to claim 1, wherein the anti-correlated noise filter is further configured to filter noise according to a function defined by:
$$( \hat{p} , \hat{s} ) = arg {min}_{( p , s )} R ( p ) + R ( s ) + \frac{1}{2} \int {{λ}^{u} ( p + s - {u}^{0} )}^{2} + \frac{1}{2} \int {{λ}^{p} ( p - {p}^{0} )}^{2} + \frac{1}{2} \int {{λ}^{s} ( s - {s}^{0} )}^{2} ,$$
where R(p) and R(s) are roughness penalties for p and s, respectively, u⁰ is an image volume where the correlated noise maximally cancels out with the initially decomposed portions, p⁰ and s⁰, e.g., u⁰=p⁰+s⁰, p and s are the filtered image volumes, and λ^{u}, λ^{p} and λ^{s} are weights.

5. The imaging system according to claim 4, wherein the function is implemented by:
$$\begin{matrix}{s}_{i , j , k}^{n + 1} = \frac{{λ}_{i , j , k}^{u} ( {u}_{i , j , k}^{0} - {p}_{i , j , k}^{n} ) + {λ}_{i , j , k}^{s} {s}_{i , j , k}^{0} + {δΣ}_{D} {σ}_{D}^{n} {s}_{D}^{n}}{{λ}_{i , j , k}^{u} + {λ}_{i , j , k}^{s} + {δΣ}_{D} {σ}_{D}^{n}} \\ and \\ {p}_{i , j , k}^{n + 1} = \frac{{λ}_{i , j , k}^{u} ( {u}_{i , j , k}^{0} - {s}_{i , j , k}^{n} ) + {λ}_{i , j , k}^{p} {s}_{i , j , k}^{0} + {δΣ}_{D} {ϕ}_{D}^{n} {s}_{D}^{n}}{{λ}_{i , j , k}^{u} + {λ}_{i , j , k}^{p} + {δΣ}_{D} {ϕ}_{D}^{n}}\end{matrix}$$
where λ^{u}, λ^{p}, λ^{s}, σ_{D} are weights, p⁰ and s⁰ are the first and second decomposed portions, pⁿ and sⁿ are current values of the n^{th} iteration of p⁰ and s⁰, pⁿ⁺¹ and sⁿ⁺¹ are a next iteration filter first and second portion, D includes a set of each orthogonal three dimensional direction {E(ast), W(est), S(outh), N(orth), U(p), and (d)O(wn)}, and i,j,k represent a current voxel in the image volume or a position in projection space volume, and δ is a Huber parameter.

6. The imaging system according to claim 1, wherein the anti-correlated noise filter is further configured to filter noise according to the function defined by:
$$( \hat{s} , \hat{p} ) = arg {min}_{( s , p )} α R ( s ) + ( 1 - α ) R ( p )$$
subject to the constraints that (s.t.)
1. s and p are obtained by removing negatively correlated estimated noise from s⁰ and p⁰, respectively;
2. \hat{m} monochromatic image is unchanged; and
3. image frequencies outside band frequencies are unchanged,
where R(p) and R(s) are roughness penalties or regularization terms for p and s, respectively, \hat{m} is an energy level parameter in keV unit, and α is an algorithm control parameter.

7. The imaging system according to claim 6, wherein the function is implemented by detecting a spectral virtual monochromatic image, \hat{m}, in which the anti-correlated noise is minimized, and the generating a new s and p based on the detected monochromatic image, and \hat{m} is defined by:
$$\hat{m} = arg {min}_{m} \frac{R ( {c}_{s} ( m ) s + {c}_{P} ( m ) p )}{{c}_{s} ( m ) R ( s ) + {c}_{p} ( m ) R ( p )} ,$$
where cₛ(m) and cₚ (m) are the coefficients of the first decomposed portion, s and the second decomposed portion, p, respectively, that enable the algorithm to obtain the monochromic image \hat{m} for energy \hat{m} keV.

8. The imaging system according to claim 6, wherein the function is implemented by detecting a spectral virtual monochromatic image, \hat{m} by defining a selection region of the combined spectral data using a predetermined threshold value, a local standard deviation calculated for a neighborhood of size ne for the combined spectral data, a set, q, of locations is created of an r smallest local standard deviations located in the selection region and \hat{m} is defined by:
$$\hat{m} = arg {min}_{m} Σ localstddev ( {c}_{s} ( m ) s + {c}_{p} ( m ) p , q , ne ) ,$$
where the local standard deviation is calculated only over the set q and ne specify the neighborhood of the local standard deviation.

9. The imaging system according to claim 1, wherein the anti-correlated noise filter is further configured to filter noise according to the function defined by:
\hat{p}=p⁰Â and ŝ=ŝ=s⁰+Â,
where
$$\hat{A} = {\hat{A}}_{{L}_{1}} + ScaleUp ( {\hat{A}}_{{L}_{2}}^{d} - ScaleDown ( {\hat{A}}_{{L}_{1}} , d ) , d ) , \\ {\hat{A}}_{{L}_{1}} = {argmin }_{A} R ( {s}^{0} + A ) + R ( {p}^{0} - A ) + \int {λ}_{1} {h}_{δ} ( A ) , \\ {\hat{A}}_{{L}_{2}}^{d} = {argmin }_{A} R ( {s}_{d}^{0} + A ) + R ( {p}_{d}^{0} - A ) + \int {λ}_{2} {A}^{2} ,$$
s_{d}⁰=ScaleDown (s⁰, d), p_{d}⁰=ScaleDown (p⁰, d), d is a scale parameter, R(·) is a roughness penalty or regularization term, λ₁ and λ₂ are weights, Â is the estimated anti-correlated noise image, A is a prior estimate of the anti-correlated noise image, h_{δ}(A)=δ²(\sqrt{1+(A/δ)²}−1)is the pseudo-Huber penalty function and δ is the pseudo-Huber parameter.

10. The imaging system according to claim 1, wherein the anti-correlated noise filter is further configured to filter noise according to the function defined by:
\hat{p}=p⁰−Â and ŝ=s⁰+Â,
where
$$\hat{A} = {\hat{A}}_{{L}_{1}} + ScaleUp ( {\hat{A}}_{{L}_{2}}^{d} , d ) , \\ {\hat{A}}_{{L}_{1}} = {argmin }_{A} R ( {s}^{0} + A ) + R ( {p}^{0} - A ) + \int \frac{{λ}_{1}}{n} {h}_{δ} ( A ) , and \\ {\hat{A}}_{{L}_{2}}^{d} = {argmin }_{A} R ( {s}_{d}^{0} + A ) + R ( {p}_{d}^{0} - A ) + \int ( \frac{{λ}_{2}}{{n}^{2}} + {λ}_{3} F ) {A}^{2} ,$$
where s_{d}⁰=ScaleDown (s⁰+Â_{L}_{₁}, d), p_{d}⁰=ScaleDown (p⁰−Â_{L}_{₁}, d), d is a scale parameter, R(·) is a roughness penalty or regularization term, λ₁, λ₂ and λ₃ are weights, Â is the estimated anti-correlated noise image, A is a prior estimate of the anti-correlated noise image, h_{δ}(A)=δ²(\sqrt{1+(A/δ)²}−1) is the pseudo-Huber penalty function, δ is the pseudo-Huber parameter, n is an estimated noise map, and
$$F = ScaleDown ( \frac{σ ( {s}_{d}^{0} + {\hat{A}}_{{L}_{1}} ) σ ( {p}_{d}^{0} - {\hat{A}}_{{L}_{1}} )}{1 + {σ ( {\hat{A}}_{{L}_{1}} )}^{2}} ) ,$$
where σ(x) is the local standard deviation of the image ^{x} .

11. The imaging system according to claim 1, wherein the first portion and the second portion are basis pairs and include at least one of:
a photoelectric absorption component and a Compton-scatter component;
a water component and an Iodine component;
a water component and a Calcium component; or
an acetal homopolymer resin component and a tin components.

12. The imaging system according to claim 1, wherein the anti-correlated noise filter is further configured to iteratively filter noise from the first portion and the second portion until a stopping criteria is reached.

13. The imaging system according to claim 1, wherein the anti-correlated noise filter is further configured to filter separately the first portion and the second portion with a Structure Propagation (SP) filter prior to jointly filtering anti-correlated noise from the SP filtered first portion and the SP filtered second portion.

14. A method of filtering image data, comprising:
jointly filtering noise from a first portion and a second portion, and the first portion and the second portion include anti-correlated noise.

15. The method according to claim 14, wherein the first portion and the second portion are formed from a basis decomposition of spectral CT data, which includes at least one of:
projection data of an object or subject; or
imaging data of an object or subject.

16. The method according to claim 14, wherein jointly filtering includes at least one of:
weighting a difference between initially combined data of the first portion and the second portions, and a sum of a filtered first portion and a filtered second portion; and
selecting the filtered first portion and the filtered second portion to minimize noise in a spectral monochromatic image which includes a weighted combination of the filtered first portion and the filtered second portion.

17. The method according to claim 14, wherein filtering noise filtered according to the function defined by:
$$( \hat{p} , \hat{s} ) = {argmin}_{( p , s )} R ( p ) + R ( s ) + \frac{1}{2} \int {λ}^{u} ( p + s - {u}^{0} ) + \frac{1}{2} \int {{λ}^{p} ( p - {p}^{0} )}^{2} + \frac{1}{2} \int {{λ}^{s} ( s - {s}^{0} )}^{2} ,$$
where R(p) and R(s) are roughness penalties for p and s, respectively, u⁰ is an image volume where the correlated noise maximally cancels out with the initially decomposed portions, p⁰ and s⁰, e.g., u⁰=p⁰+s⁰, p and s are the filtered image volumes, and λ^{u}, λ^{p} and λ² are weights.

18. The method according to claim 14, wherein the function is implemented by:
$${s}_{i , j , k}^{n + 1} = \frac{{λ}_{i , j , k}^{u} ( {u}_{i , j , k}^{0} - {p}_{i , j , k}^{n} ) + {λ}_{i , j , k}^{s} {s}_{i , j , k}^{0} + δ {\sum }_{D} {σ}_{D}^{n} {s}_{D}^{n}}{{λ}_{i , j , k}^{u} + {λ}_{i , j , k}^{s} + δ {\sum }_{D} {σ}_{D}^{n}}$$
$$and$$
$${p}_{i , j , k}^{n + 1} = \frac{{λ}_{i , j , k}^{u} ( {u}_{i , j , k}^{0} - {s}_{i , j , k}^{n} ) + {λ}_{i , j , k }^{p} {s}_{i , j , k}^{0} + δ {\sum }_{D} {ϕ}_{D}^{n} {s}_{D}^{n}}{{λ}_{i , j , k}^{u} + {λ}_{i , j , k}^{p} + δ {\sum }_{D} {ϕ}_{D}^{n}}$$
where λ^{u}, λ^{p}, λ^{s}, σ_{D} are weights, p⁰and s⁰ are the first and second decomposed portions, pⁿ and sⁿ are current values of the n^{th} iteration of p⁰ and s⁰, pⁿ⁺¹ and sⁿ⁺¹ are a next iteration filter first and second portion, D includes a set of each orthogonal three dimensional direction {E(ast), W(est), S(outh), N(orth), U(p), and (d)O(wn)}, and i,j,k represent a current pixel, and δ is a Huber parameter.

19. The method according to claim 14, wherein filtering noise is filtered according to the function defined by:
$$( \hat{s} , \hat{p} ) = arg {min}_{( s , p )} α R ( s ) + ( 1 - α ) R ( p )$$
subject to the constraints that (s.t)
1. s and p are obtained by removing negatively correlated estimated noise from s⁰ and p⁰, respectively;
2. \hat{m} monochromatic image is unchanged; and
3. image frequencies outside band frequencies are unchanged,
where R(p) and R(s) are roughness penalties or regularization terms for p and s, respectively, \hat{m} is an energy level parameter in keV unit, and α is an algorithm control parameter.

20. The method according to claim 19, wherein the function is implemented by detecting a spectral virtual monochromatic image, \hat{m}, in which the anti-correlated noise is minimized, and the generating a new s and p based on the detected monochromatic image, and \hat{m} is defined by:
$$\hat{m} = arg {min}_{m} \frac{R ( {c}_{s} ( m ) s + {c}_{p} ( m ) p )}{{c}_{s} ( m ) R ( s ) + {c}_{p} ( m ) R ( p )} ,$$
where cₛ(m) and cₚ (m) are the coefficients of the first decomposed portion, s and the second decomposed portion, p, respectively, that enable the algorithm to obtain the monochromic image \hat{m} for energy \hat{m} M in keV.

21. The imaging system according to claim 19, wherein the function is implemented by detecting a spectral virtual monochromatic image, \hat{m} by defining a selection region of the combined spectral data using a predetermined threshold value, such as −200 HU. A local standard deviation is calculated for a neighborhood of size ne for the combined spectral data. A set, q of locations is created of the r smallest local standard deviations located in the selection region and an example of \hat{m} is defined by:
$$\hat{m} = arg {min}_{m} \sum localstddev ( {c}_{s} ( m ) s + {c}_{p} ( m ) , p , q , ne ) ,$$
where the local standard deviation is calculated only over the set q and ne specify the neighbourhood of the local standard deviation.

22. The method according to claim 14, wherein filtering noise is filtered according to the function defined by:
\hat{p}=p⁰−Â and ŝ=s⁰+Â,
where
$$\hat{A} = {\hat{A}}_{{L}_{1}} + ScaleUp ( {\hat{A}}_{{L}_{2}}^{d} - ScaleDown ( {\hat{A}}_{{L}_{1}} , d ) , d ) , \\ {\hat{A}}_{{L}_{1}} = {argmin}_{A} R ( {s}^{0} + A ) + R ( {p}^{0} - A ) + \int {λ}_{1} {h}_{δ} ( A ) , \\ {\hat{A}}_{{L}_{2}}^{d} = {argmin}_{A} R ( {s}_{d}^{0} + A ) + R ( {p}_{d}^{0} - A ) + \int {λ}_{2} {A}^{2} ,$$
where s_{d}⁰=ScaleDown (s⁰, d), p_{d}⁰=ScaleDown (p⁰, d), d is a scale parameter, R(·) is a roughness penalty or regularization term, λ₁ and λ₂ are weights, Â is the estimated anti-correlated noise image, A is a prior estimate of the anti-correlated noise image, h_{δ}(A)=δ²(\sqrt{1+(A/δ)²}−1) is the pseudo-Huber penalty function and δ is the pseudo-Huber parameter.

23. The method according to claim 14, wherein filtering noise is filtered according to the function defined by:
\hat{p}=p⁰−Â and ŝ=s⁰+Â,
where
$$\hat{A} = {\hat{A}}_{{L}_{1}} + ScaleUp ( {\hat{A}}_{{L}_{2}}^{d} , d ) , \\ {\hat{A}}_{{L}_{1}} = {argmin}_{A} R ( {s}^{0} + A ) + R ( {p}^{0} - A ) + \int {λ}_{1} {h}_{δ} ( A ) , and$$
$${\hat{A}}_{{L}_{2}}^{d} = {argmin}_{A} R ( {s}_{d}^{0} + A ) + R ( {p}_{d}^{0} - A ) + \int ( \frac{{λ}_{2}}{{n}^{2}} + {λ}_{3} F ) {A}^{2} ,$$
where s_{d}⁰=ScaleDown (s⁰+Â_{L}_{₁}, d), p_{d}⁰=ScaleDown (p⁰−Â_{L}_{₁}, d), d is a scale parameter, R(·) is a roughness penalty or regularization term, λ₁, λ₂ and λ₃ are weights, Â is the estimated anti-correlated noise image, A is a prior estimate of the anti-correlated noise image, h_{δ}(A)=δ²(\sqrt{1+(A/δ)²}−1) is the pseudo-Huber penalty function, δ is the pseudo-Huber parameter, n is an estimated noise map, and
$$F = ScaleDown ( \frac{σ ( {s}_{d}^{0} + {\hat{A}}_{{L}_{1}} ) σ ( {p}_{d}^{0} - {\hat{A}}_{{L}_{1}} )}{1 + {σ ( {\hat{A}}_{{L}_{1}} )}^{2}} ) ,$$
where σ(^{x}) is the local standard deviation of the image ^{x} .

24. The method according to claim 14, wherein the first portion and the second portion are formed from basis decomposition of CT spectral imaging data and decomposed into basis pairs which include at least one of:
a photoelectric absorption component and a Compton-scatter component;
a water component and an Iodine component;
a water component and a Calcium component; or
an acetal homopolymer resin component and a tin components.

25. The method according to claim 14, wherein filtering further includes:
filtering separately the first portion and the second portion using a Structure Propagation (SP) filter prior to jointly filtering anti-correlated noise from the SP filtered first portion and the SP filtered second portion.

26. A non-transitory computer readable storage medium encoded with computer readable instructions, which, when executed by a processor, causes the processor to:
jointly filter noise from a first portion and a second portion, and the first portion and the second portion include anti-correlated noise, and the filter operates iteratively according to at least one of the following functions:
$$( \hat{p} , \hat{s} ) = {argmin}_{( p , s )} R ( p ) + R ( s ) + \frac{1}{2} \int {{λ}^{u} ( p + s - {u}^{0} )}^{2} + \frac{1}{2} \int {{λ}^{p} ( p - {p}^{0} )}^{2} + \frac{1}{2} \int {{λ}^{s} ( s - {s}^{0} )}^{2} ,$$
where R(p) and R(s) are roughness penalties for p and s, respectively, u⁰ is an image volume where the correlated noise maximally cancels out with the initially decomposed portions, p⁰ and s⁰, e.g., u⁰=p⁰+s⁰, p and s are the filtered image volumes, and λ^{u}, λ^{p} and λ^{s} are weights; or
$$( \hat{s} , \hat{p} ) = arg {min}_{( s , p )} α R ( s ) + ( 1 - α ) R ( p )$$
subject to the constraints that (s.t.)
1. s and p are obtained by removing negatively correlated estimated noise from s⁰ and p⁰, respectively;
2. \hat{m} monochromatic image is unchanged; and
3. image frequencies outside band frequencies are unchanged,
where R(p) and R(s) are roughness penalties or regularization terms for p and s, respectively, \hat{m} is an energy level parameter in keV unit, and α is an algorithm control parameter;
\hat{p}=p⁰−Â and ŝ=s⁰+Â,
where
$$\hat{A} = {\hat{A}}_{{L}_{1}} + ScaleUp ( {\hat{A}}_{{L}_{2}}^{d} - ScaleDown ( {\hat{A}}_{{L}_{1}} , d ) , d ) , \\ {\hat{A}}_{{L}_{1}} = {argmin}_{A} R ( {s}^{0} + A ) + R ( {p}^{0} - A ) + \int {λ}_{1} {h}_{δ} ( A ) , \\ {\hat{A}}_{{L}_{2}}^{d} = {argmin}_{A} R ( {s}_{d}^{0} + A ) + R ( {p}_{d}^{0} - A ) + \int {λ}_{2} {A}^{2} ,$$
where s_{d}⁰=ScaleDown (s⁰, d), p_{d}⁰=ScaleDown (p⁰, d), d is a scale parameter, R(·) is a roughness penalty or regularization term, λ₁ and λ₂ are weights, Â is the estimated anti-correlated noise image, A is a prior estimate of the anti-correlated noise image, h_{δ}(A)=δ²(\sqrt{1+(A/δ)²}−1) is the pseudo-Huber penalty function and δ is the pseudo-Huber parameter; or
\hat{p}=p⁰−Â and ŝ=s⁰+Â,
where
$$\hat{A} = {\hat{A}}_{{L}_{1}} + ScaleUp ( {\hat{A}}_{{L}_{2}}^{d} , d ) , \\ {\hat{A}}_{{L}_{1}} = {argmin}_{A} R ( {s}^{0} + A ) + R ( {p}^{0} - A ) + \int \frac{{λ}_{1}}{n} {h}_{δ} ( A ) , and$$
$${\hat{A}}_{{L}_{2}}^{d} = {argmin}_{A} R ( {s}_{d}^{0} + A ) + R ( {p}_{d}^{0} - A ) + \int ( \frac{{λ}_{2}}{{n}^{2}} + {λ}_{3} F ) {A}^{2} ,$$
where s_{d}⁰=ScaleDown (s⁰+Â_{L}_{₁}, d), p_{d}⁰=ScaleDown (p⁰−Â_{L}_{₁}, d), d is a scale parameter, R(·) is a roughness penalty or regularization term, λ₁, λ₂ and λ₃ are weights, Â is the estimated anti-correlated noise image, A is a prior estimate of the anti-correlated noise image, h_{δ}(A)=δ²(\sqrt{1+(A/δ)²}−1) is the pseudo-Huber penalty function, δ is the pseudo-Huber parameter, n is an estimated noise map, and
$$F = ScaleDown ( \frac{σ ( {s}_{d}^{0} + {\hat{A}}_{{L}_{1}} ) σ ( {p}_{d}^{0} - {\hat{A}}_{{L}_{1}} )}{1 + {σ ( {\hat{A}}_{{L}_{1}} )}^{2}} ) ,$$
where σ(x) is the local standard deviation of the image ₓ.
